(19) United States
(12) Patent Application Publication
(10) Pub. No.: US 2012/0325060 A1
(43) Pub. Date: Dec. 27, 2012

(54) ANGULARLY ACCESSIBLE HEAD ASSEMBLY FOR A TORQUE HAND TOOL

(76) Inventor: Chin-Tan Huang, Taichung City (TW)

(21) Appl. No.: 13/307,693

(22) Filed: Nov. 30, 2011

(30) Foreign Application Priority Data
Jun. 24, 2011 (TW) 100122228

(51) Int. Cl. B25B 23/16

(52) U.S. Cl. 81/177.75

(57) ABSTRACT

An angularly accessible head assembly for a torque hand tool includes a drive shank and a head rotatably disposed on a coupling shell about drive and driven axes that intersect with each other by an angle of at least 90 degrees. First, second and third force transmitting members are disposed to couple the drive shank and the head by means of four joint subassemblies, each having a socket wall surface and an orientable portion matingly engaged with each other. A torque exerted upon the drive shank is transmitted to the head through the force transmitting members and the joint subassemblies so as to activate a rotational movement of a threaded connector.

### CROSS-REFERENCE TO RELATED APPLICATION

This application claims priority of Taiwanese Patent Application No. 100122228, filed on Jun. 24, 2011, the disclosure of which is herein incorporated by reference.

### BACKGROUND OF THE INVENTION

1. Field of the Invention

This invention relates to a head for a torque hand tool, more particularly to an angularly accessible head assembly having a drive shank and a head which are rotatable about two intersecting axes.

2. Description of the Related Art

A conventional tool head generally includes a bevel gear assembly to interconnect two shafts so as to permit the rotating axes of the shafts to intersect such that a turning force applied to one of the shafts can rotate the other one of the shafts at different angle to thereby rotate a workpiece attached to the other one of the shafts. Since the turning force is transmitted by means of mesh engagement between teeth on the bevel gears, mounting of the teeth must be precise and the teeth are liable to be worn as a result of improper use.

Another conventional type of tool heads, such as those disclosed in U.S. Pat. No. 3,897,703, TW20080208543, etc., includes driving and driven shanks coupled to each other at connecting ends such that one shank is disposed parallel or inclined to the other shank. The connecting ends respectively have a polygonal socket cavity and a polygonal ball joint which are engaged with each other. The polygonal ball joint has a plurality of rounded sides so as to be pivotable to an angle of 45 degrees in maximum with respect to the socket cavity. Hence, such tool head is not suitable for use in a working space which requires a working angle of more than 45 degrees. Besides, slipping movement of a driven shank relative to the driving shank might occur incidentally thus rendering the operation of the tool head inconvenient and unsuccessful.

### SUMMARY OF THE INVENTION

An object of the present invention is to provide an angularly accessible head assembly which performs a relatively large working angle and which is operated conveniently and efficiently.

According to this invention, the angularly accessible head assembly includes a coupling shell having a drive-side chamber which extends along a drive axis, a driven-side chamber which extends along a driven axis that is oriented to intersect with the drive axis, and a force transmitting chamber which is interposed between and communicated with the drive-side and driven-side chambers. A drive shank extends along the drive axis to terminate at an actuating end for manipulation, and an actuated end which is rotatably mounted in the drive-side chamber. A head is rotatably mounted in the driven-side chamber about the driven axis. A force transmitting member is rotatably mounted in the force transmitting chamber about a transmitting axis that is oriented to intersect with the drive axis, and has force-receiving and force-delivering ends opposite to each other along the transmitting axis. A joint subassembly is disposed between the actuated end and the force-receiving end to transmit a torque exerted on the actuated end to rotate the force-receiving end about the first transmitting axis. The joint subassembly has a socket wall surface disposed on one of the actuated end and the force-receiving end, and defining a socket cavity, and an orientable portion inserted in the socket cavity, and disposed on the other one of the actuated end and the first force-receiving end. The orientable portion has an encircling contact region which is in frictional engagement with the socket wall surface in a plane substantially normal to the corresponding axis of the socket wall surface such that the torque exerted upon the actuated end is reliably transmitted to rotate the head about the driven axis.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a partially sectioned side view of the first embodiment of an angularly accessible head assembly according to this invention;

FIG. 2 is a cross-sectional view taken along line II-II of FIG. 1;

FIG. 3 is a cross-sectional view taken along line III-III of FIG. 1;

FIG. 4 is a perspective view of a force transmitting member of the first embodiment;

FIG. 5 is a cross-sectional view taken along line V-V of FIG. 1;

FIG. 6 is a cross-sectional view similar to FIGS. 2, 3 and 5, illustrating a modified form;

FIG. 7 is a partially sectioned side view of the second embodiment of an angularly accessible head assembly according to this invention;

FIG. 8 is a partially sectioned side view of the third embodiment of an angularly accessible head assembly according to this invention;

FIG. 9 is a partially sectioned side view of the fourth embodiment of an angularly accessible head assembly according to this invention;

FIG. 10 is a partially sectioned side view of the fifth embodiment of an angularly accessible head assembly according to this invention;

FIG. 11 is a perspective view of a force transmitting member of the fifth embodiment; and

FIG. 12 is a partially sectioned side view of the sixth embodiment of an angularly accessible head assembly according to this invention.

### DETAILED DESCRIPTION OF THE PREFERRED EMBODIMENTS

Before the present invention is described in greater detail, it should be noted that same reference numerals have been used to denote like elements throughout the specification.

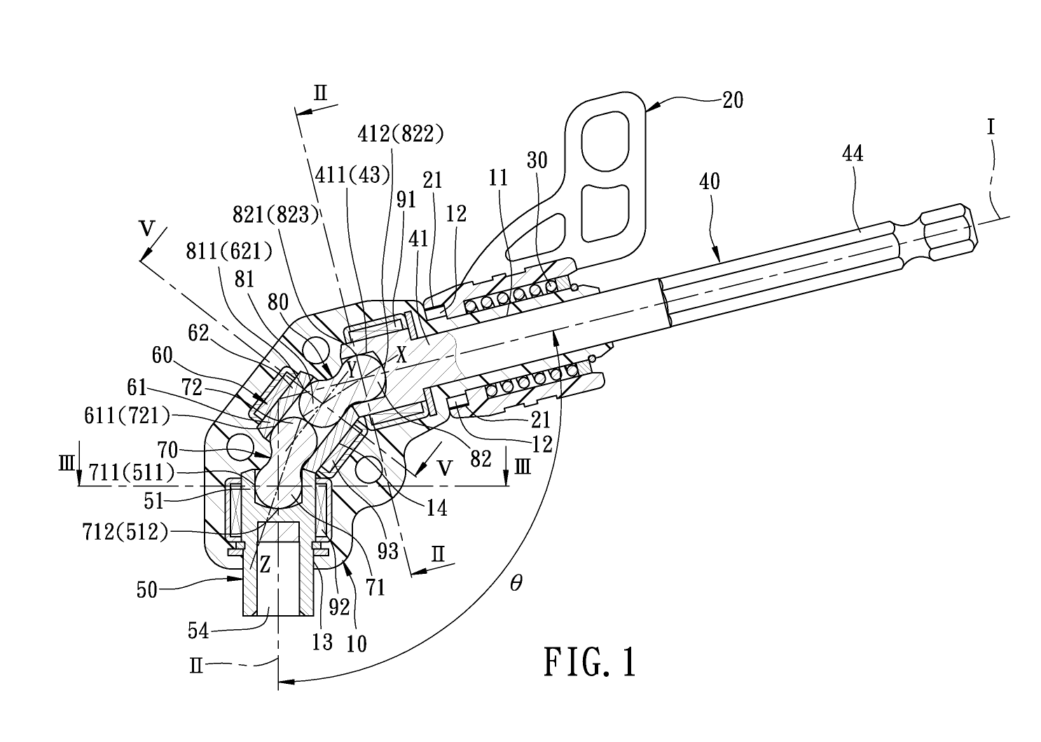

Referring to FIG. 1, the first embodiment of an angularly accessible head assembly according to the present invention is shown to comprise a coupling shell 10, a handle 20, a biasing member 30, a drive shank 40, a head 50, a first force transmitting member 80, a first joint subassembly 411, 821, a second force transmitting member 60, a second joint subassembly 621, 811, a third force transmitting member 70, a third joint subassembly 611, 721, and a fourth joint subassembly 711, 511.

The coupling shell 10 has a drive-side chamber 11 which defines and extends along a drive axis (I), a driven-side chamber 13 which defines and extends along a driven axis (II) that is oriented to intersect with the drive axis (I) by an angle (θ), and a force transmitting chamber 14 which is interposed between and communicated with the drive-side and driven-side chambers 11, 13. First, second and third anti-friction bearings 91, 92, 93, such as needle bearings, are respectively disposed in the drive-side, driven-side and force transmitting chambers 11, 13, 14, and are respectively formed with first, second and third bearing surfaces. A plurality of splines 12 are disposed on the coupling shell 10 around the drive axis (I). The angle (θ) is at least 90 degrees. In this embodiment, the angle (θ) is 104 degrees.

The handle 20 is movably sleeved on the coupling shell 10 and has a plurality of splined grooves 21 which are engageable with the splines 12. The handle 20 is biased by the biasing member 30 to be in spline engagement with the coupling shell 10. Thus, the user can adjust the angular position of the handle 20 relative to the coupling shell 10 for facilitating manual operation.

The drive shank 40 extends along the drive axis (I) to terminate at an actuating end 44 for manipulation, and an actuated end 41 which is rotatably mounted in the drive-side chamber 11 and borne on the bearing surface of the first anti-friction bearing 91 for delivery of a torque.

The head 50 is rotatably mounted in the driven-side chamber 13 and borne on the bearing surface of the second anti-friction bearing 92 for transmitting the torque to activate rotational movement of a threaded connector (not shown), such as a screw fastener, about the driven axis (II). The head 50 may have a polygonal socket 54 for sleeving on the threaded connector.

The first force transmitting member 80 is rotatably mounted in the force transmitting chamber 14 about a first transmitting axis (X) that is oriented to intersect with the drive axis (I), and has first force-receiving and force-delivering ends 82, 81 opposite to each other along the first transmitting axis (X). In this embodiment, the first force transmitting member 80 has two spherical bodies which respectively serve as the first force-receiving and force-delivering ends 82, 81.

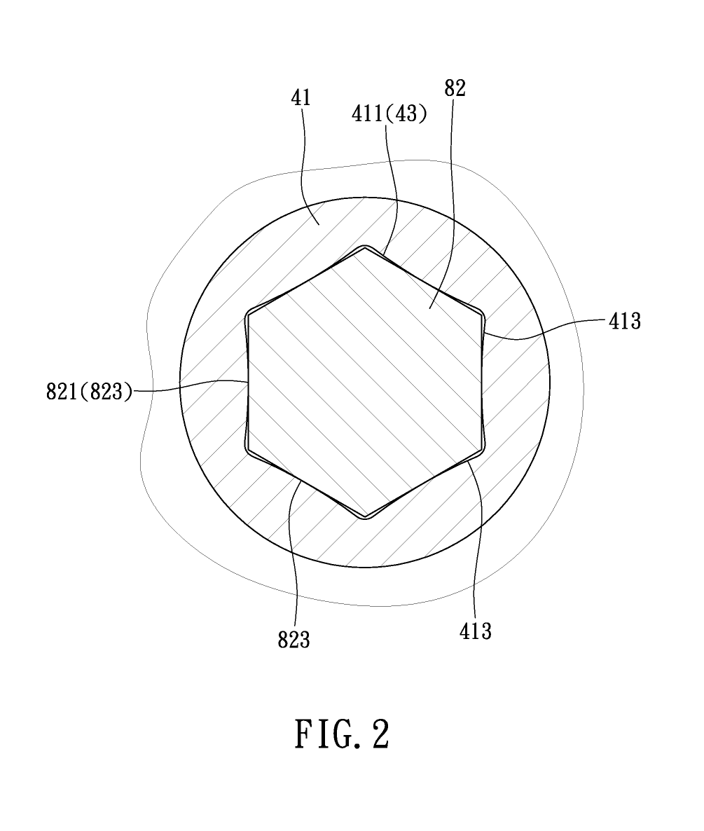

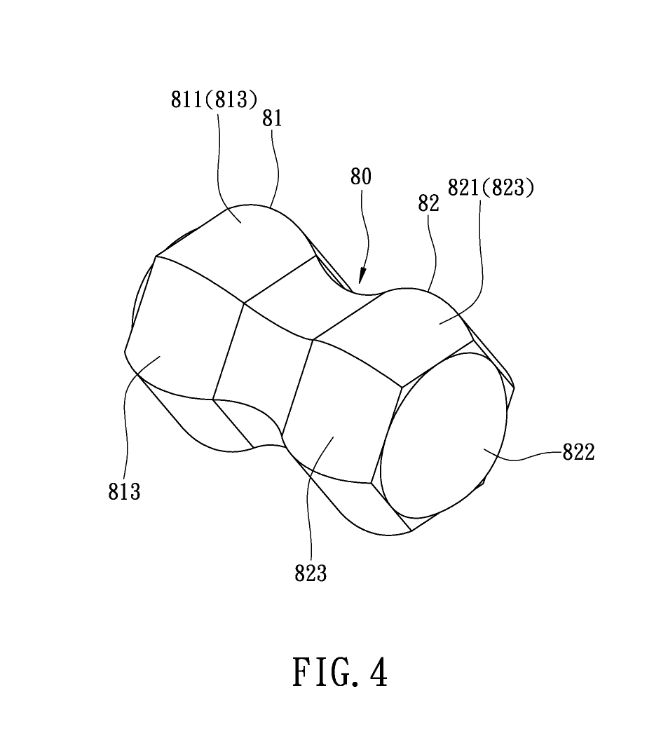

The first joint subassembly 411, 821 is disposed between the actuated end 41 and the first force-receiving end 82 to transmit the torque exerted on the actuated end 41 to rotate the first force-receiving end 82 about the first transmitting axis (X). The first joint subassembly 411, 821 has a socket wall surface 411 which is disposed on and extends from the actuated end 41, and which defines a socket cavity 43, and an orientable portion 821 which is disposed on the first force-receiving end 82 and which is inserted in the socket cavity 43. The orientable portion 821 has an encircling contact region which is in frictional engagement with the socket wall surface 411 in a plane (equivalent to a plane taken by line II-II of FIG. 1) substantially normal to the drive axis (I). As shown in FIGS. 2 and 4, the orientable portion 821 has a spherical cap end 822 which defines a diametrical axis that is in line with the first transmitting axis (X) and which is matingly engaged with a concaved bottom surface 412 of the socket cavity 43, and a polygonal cross-section with a plurality of flat surface areas 823 to be in frictional engagement with a plurality of convex surface areas 413 of the socket wall surface 411 while permitting slight movement therebetween. Hence, when the actuating end 44 of the drive shank 40 is rotated manually about the drive axis (I), the torque exerted upon the actuated end 41 is transmitted to rotate the first force transmitting member 80 about the first transmitting axis (X).

The second force transmitting member 60 is rotatably mounted in the force transmitting chamber 14 about a second transmitting axis (Y) that is oriented to intersect with the first transmitting axis (X), and which has second force-receiving and force-delivering ends 62, 61 opposite to each other along the second transmitting axis (Y). In this embodiment, the second force transmitting member 60 is in form of a tubular body which surrounds the second transmitting axis (Y) and which is rotatably borne on the bearing surface of the third anti-friction bearing 93.

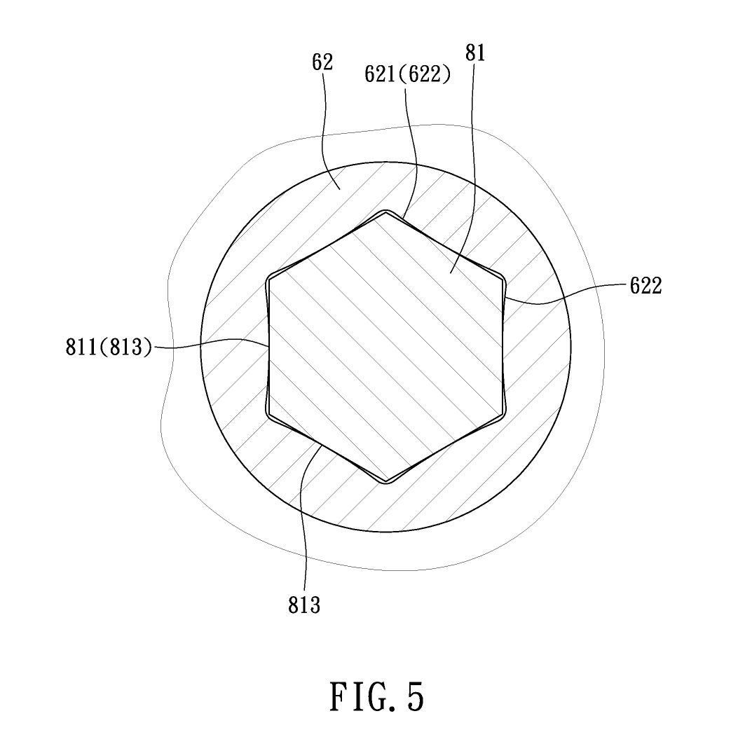

The second joint subassembly 811, 621 is disposed between the first force-delivering end 81 and the second force-receiving end 62 to transmit the torque exerted on the first force-delivering end 81 to rotate the second force-receiving end 62 about the second transmitting axis (Y). Similarly, as shown in FIGS. 4 and 5, the second joint subassembly 811, 621 has a socket wall surface 621 which is disposed on the force-receiving end 62 and which has a plurality of convex surface areas 622, and an orientable portion 811 which is disposed on the first force-delivering end 81 and which has a plurality of flat surface areas 813 in frictional engagement with the convex surface areas 622 while permitting a slight movement therebetween.

The third force transmitting member 70 is rotatably mounted in the force transmitting chamber 14 about a third transmitting axis (Z) that is oriented to intersect with the second transmitting axis (Y), and has third force-receiving and force-delivering ends 72, 71 opposite to each other along the third transmitting axis (Z). In this embodiment, the third force transmitting member 70, similar to the first force transmitting member 80, has two spherical bodies which respectively serve as the third force-receiving and force-delivering ends 72, 71.

The third joint subassembly 611, 721 is disposed between the second force-delivering end 61 and the third force-receiving end 72 to transmit the torque exerted on the second force-delivering end 61 to rotate the third force-receiving end 72 about the third transmitting axis (Z). Similarly, the third joint subassembly 611, 721 has a socket wall surface 611 of a polygonal cross-section disposed on the second force-delivering end 61, and an orientable portion 721 of a polygonal cross-section disposed on the third force-receiving end 72.

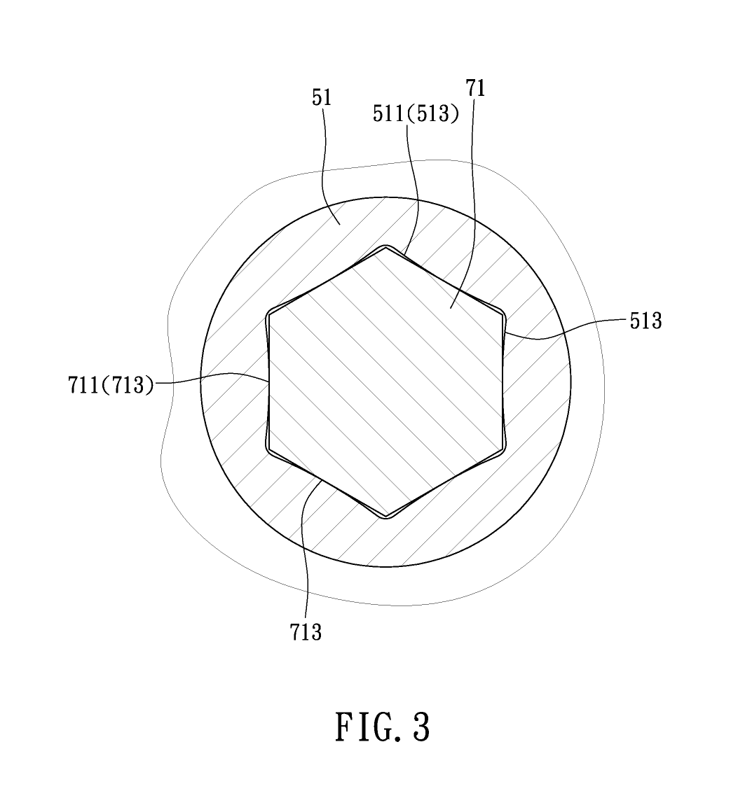

The fourth joint subassembly 511, 711 is disposed between the third force-delivering end 71 and the head 50 to transmit the torque exerted on the third force-delivering end 71 to rotate the head 50 about the driven axis (II). As shown in FIG. 3, the fourth joint subassembly 511, 711 has a socket wall surface 511 which is disposed on a force-receiving end 51 of the head 50 and which has a plurality of convex surface areas 513, and an orientable portion 711 which is disposed on the third force-delivering end 71 and which has a plurality of flat surface areas 713 in frictional engagement with the convex surface areas 513 while permitting a slight movement therebetween. The orientable portion 711 has a spherical cap end 712 matingly engaged with a concaved bottom surface 512 of the force-receiving end 51.

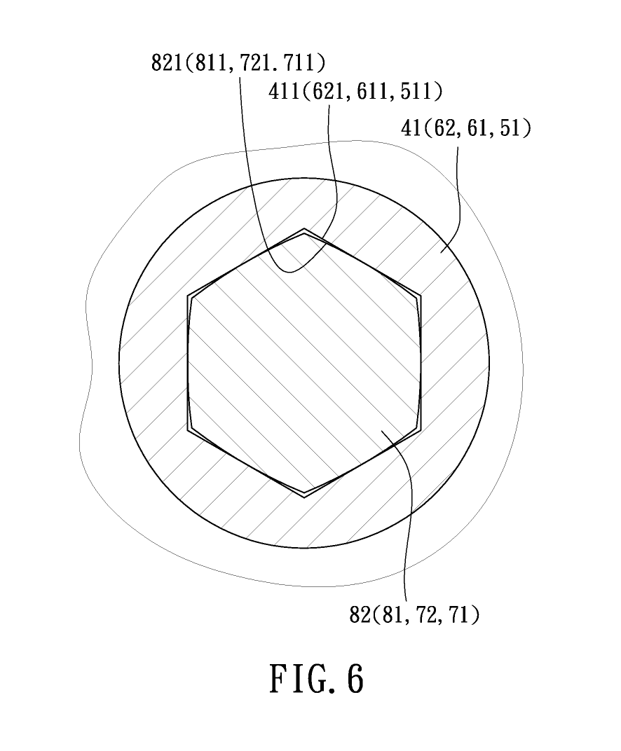

Alternatively, as shown in FIG. 6, in each of the first, second, third and fourth joint subassemblies, the socket wall surface 411, 621, 611, 511 has a plurality of flat surface areas, and the orientable portion 821, 811, 721, 711 has a plurality of convex surface areas.

When the user rotates the actuating end 44 of the drive shank 40 about the drive axis (I) through a tool, such as a wrench, the torque exerted upon the drive shank 40 is transmitted to the polygonal socket 54 of the head 50 by means of the rotational movements of the first, second and third force transmitting members 80, 60, 70 about their axes (X, Y, Z), thereby activating the rotational movement of a threaded connector surrounded by the polygonal socket 54 about the driven axis (II).

As illustrated, by engagement of the socket wall surface and the orientable portion of each joint subassembly, the torque exerted upon the drive shank 40 can be transmitted to the head 50 reliably and successfully. Further, the angle (θ) between the drive and driven axes (I, II) can be made more than 45 degrees, thereby facilitating the operation of the head assembly in narrow working spaces. Furthermore, by virtue of the bearing surfaces of the first, second and third anti-friction bearings 91, 92, 93, the rotational movements of the drive shank 40, the first, second and third force transmitting members 80, 60, 70, and the head 50 are stabilized, thereby preventing from slipping of the head 50 relative to the threaded connector.

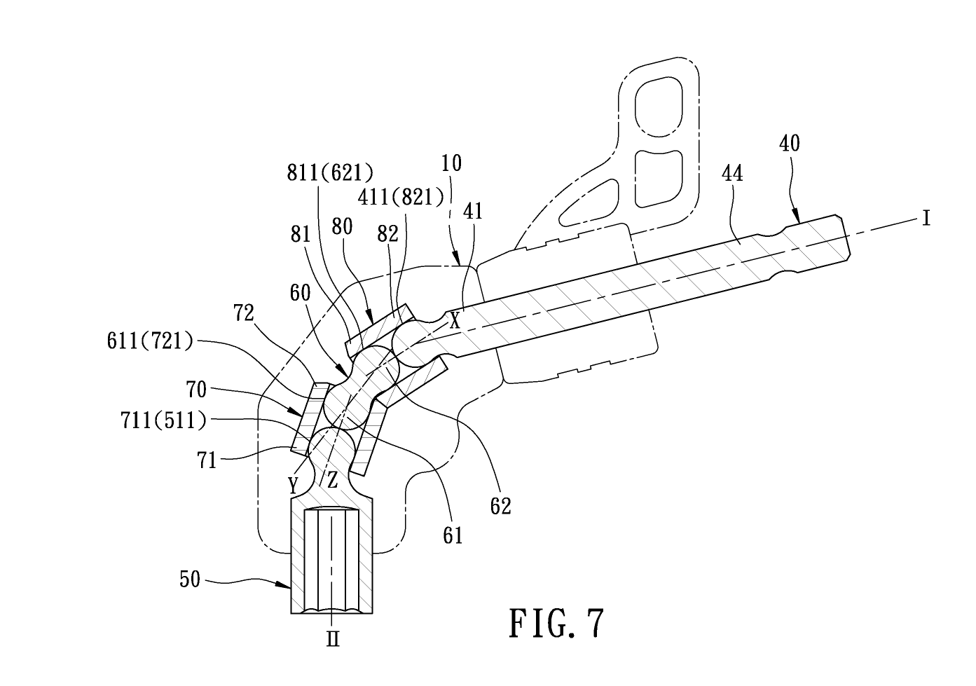

Referring to FIG. 7, the second embodiment of the angularly accessible head assembly according to this invention is similar to the first embodiment in construction. In the second embodiment, each of the first and third force transmitting members 80, 70 is in form of a tubular body which surrounds a respective one of the first and third transmitting axes (X, Z), and the second force transmitting member 60 has two spherical bodies which respectively serve as the second force-receiving and force-delivering ends 62, 61. Specifically, each of the first, second, third and fourth joint subassemblies has a socket wall surface 411, 621, 611, 511 disposed on a corresponding one of the first and third force transmitting members 80, 70, and an orientable portion 821, 811, 721, 711 is disposed on a corresponding one of the actuated end 41, the second force transmitting member 60 and the head 50.

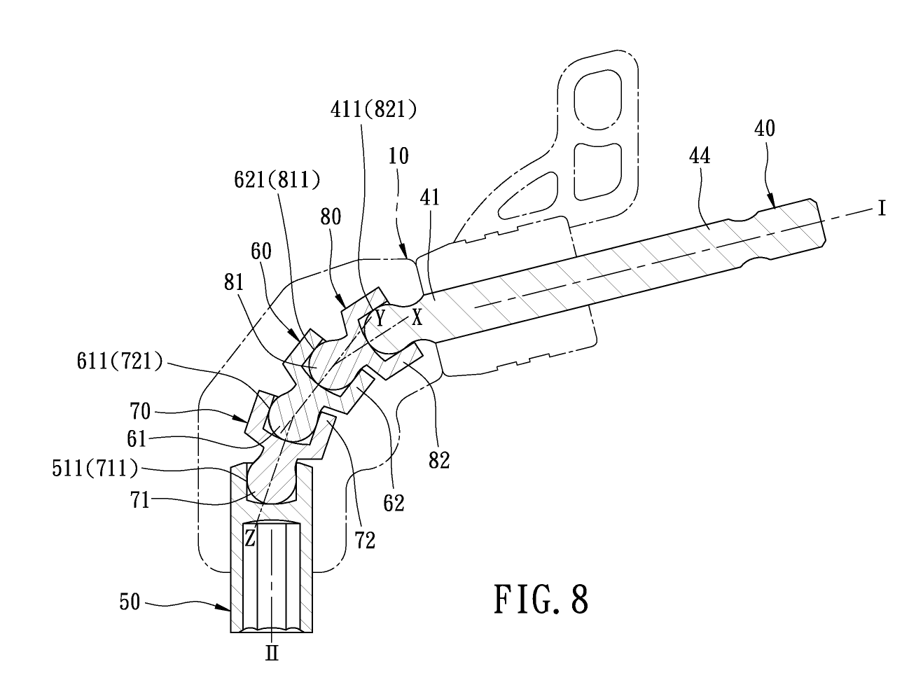

Referring to FIG. 8, the third embodiment of the angularly accessible head assembly according to this invention is similar to the first embodiment in construction. In the third embodiment, each of the first, second and third force transmitting members 80, 60, 70 is identical and has a socket body which serves as a respective one of the first, second and third force-receiving ends 82, 62, 72, and a spherical body which serves as a respective one of the first, second and third force-delivering ends 81, 61, 71. Each of the first, second, third and fourth joint subassemblies has a socket wall surface 411, 621, 611, 511 disposed on the socket body of a corresponding one of the first, second, third force transmitting members 80, 60, 70 and the head 50, and an orientable portion 821, 811, 721, 711 is disposed on the spherical body of a corresponding one of the actuated end 41 and the first, second and third force transmitting members 80, 60, 70.

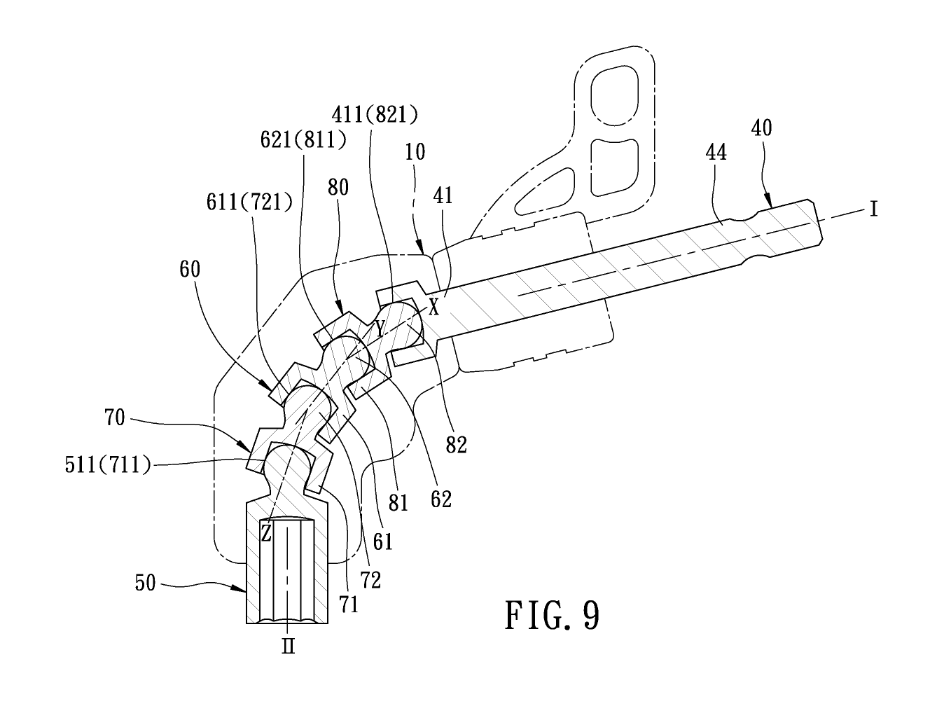

Referring to FIG. 9, the fourth embodiment of the angularly accessible head assembly according to this invention is similar to the first embodiment in construction. In the fourth embodiment, each of the first, second and third force transmitting members 80, 60, 70 is identical and has a spherical body which serves as a respective one of the first, second and third force-receiving ends 82, 62, 72, and a socket body which serves as a respective one of the first, second and third force-delivering ends 81, 61, 71. Each of the first, second, third and fourth joint subassemblies has a socket wall surface 411, 621, 611, 511 disposed on the socket body of a corresponding one of the actuated end 41 and the first, second, third force transmitting members 80, 60, 70, and an orientable portion 821, 811, 721, 711 is disposed on a corresponding one of the spherical bodies of the first, second and third force transmitting members 80, 60, 70 and the head 50.

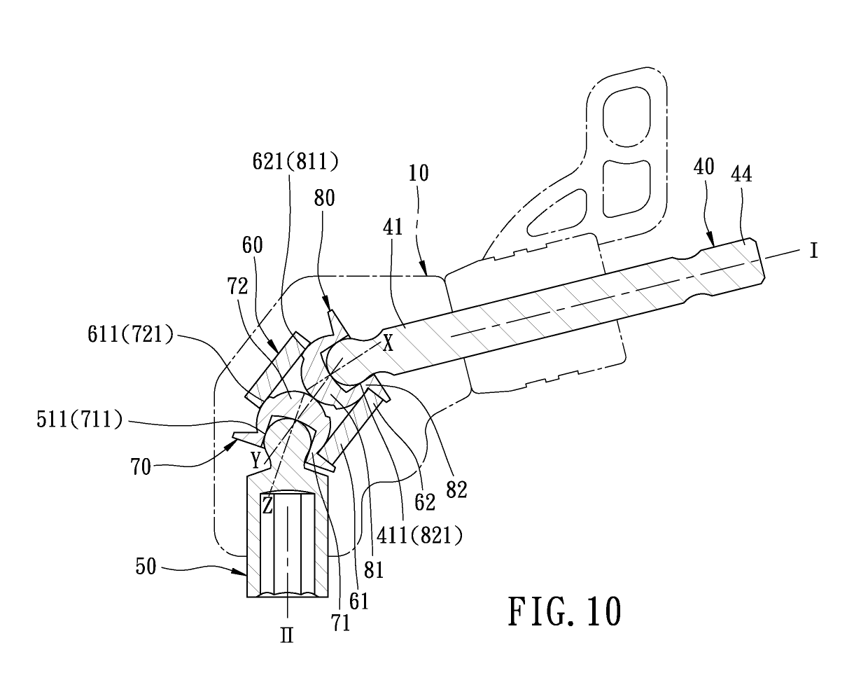

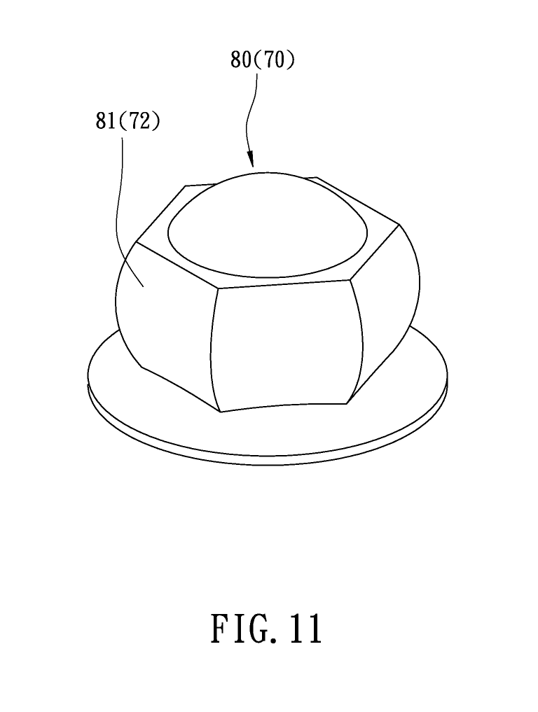

Referring to FIGS. 10 and 11, the fifth embodiment of the angularly accessible head assembly according to this invention is similar to the first embodiment in construction. In the fifth embodiment, the first force transmitting member 80 has socket and spherical bodies which respectively serve as the first force-receiving and force-delivering ends 82, 81, the second force transmitting member 60 is in form of a tubular body which surrounds the second transmitting axis (Y), and the third force transmitting member 70 has spherical and socket bodies which respectively serve as the third force-receiving and force-delivering ends 72, 71. In addition, each of the first, second, third and fourth joint subassemblies has a socket wall surface 411, 621, 611, 511 disposed on the socket body of the first force transmitting member 80, the tubular body of the second force transmitting member 60, and the socket body of the third force transmitting member 70, and an orientable portion 821, 811, 721, 711 is disposed on a corresponding one of the actuated end 41, the spherical bodies of the first and third force transmitting members 80, 70 and the head 50.

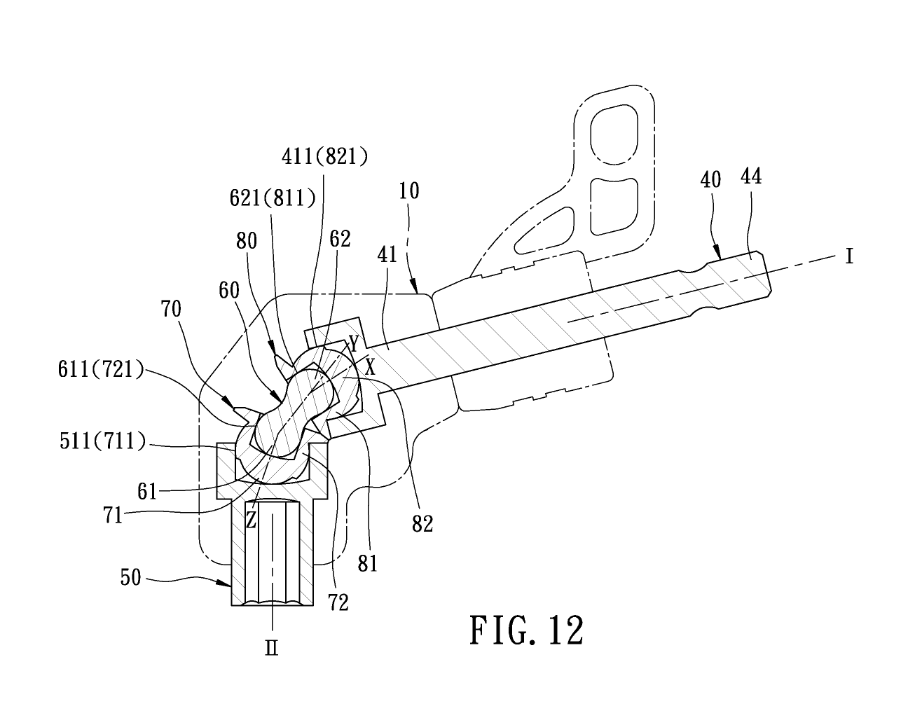

Alternatively, referring to FIG. 12, in the sixth embodiment, the first force transmitting member 80 has spherical and socket bodies which respectively serve as the first force-receiving and force-delivering ends 82, 81, the second force transmitting member 60 has two spherical bodies which respectively serve as the second force-receiving and force-delivering ends 62, 61, and the third force transmitting member 70 has socket and spherical bodies which respectively serve as the third force-receiving and force-delivering ends 72, 71.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

I claim:

1. An angularly accessible head assembly for a torque hand tool, comprising:
a coupling shell having a drive-side chamber which extends along a drive axis, a driven-side chamber which extends along a driven axis that is oriented to intersect with the drive axis by an angle, and a force transmitting chamber which is interposed between and communicated with said drive-side and driven-side chambers;
a drive shank extending along the drive axis to terminate at an actuating end for manipulation, and an actuated end which is rotatably mounted in said drive-side chamber for delivery of a torque;
a head rotatably mounted in said driven-side chamber for transmitting the torque to activate rotational movement of a threaded connector about the driven axis;
a first force transmitting member which is rotatably mounted in said force transmitting chamber about a first transmitting axis that is oriented to intersect with the drive axis, and which has first force-receiving and force-delivering ends opposite to each other along the first transmitting axis; and
a first joint subassembly disposed between said actuated end and said first force-receiving end to transmit the torque exerted on said actuated end so as to rotate said first force-receiving end about the first transmitting axis, said first joint subassembly having
a socket wall surface disposed on one of said actuated end and said first force-receiving end, and defining a socket cavity, and
an orientable portion which is inserted in said socket cavity, and which is disposed on the other one of said actuated end and said first force-receiving end, said orientable portion having an encircling contact region which is in frictional engagement with said socket wall surface in a plane substantially normal to the corresponding one of the drive axis and the first transmitting axis of said one of said actuated end and said first force-receiving end.

2. The angularly accessible head assembly as claimed in claim 1, wherein said orientable portion has a spherical cap end which defines a diametrical axis that is in line with the corresponding one of the drive axis and the first transmitting axis.

3. The angularly accessible head assembly as claimed in claim 2, wherein said socket wall surface and said encircling contact region respectively have polygonal cross-sections to be matingly engaged with each other.

4. The angularly accessible head assembly as claimed in claim 3, wherein one of said encircling contact region and said socket wall surface includes a plurality of flat surface areas, and the other one of said encircling contact region and said socket wall surface includes a plurality of convex surface areas configured to be in frictional engagement with said flat surface areas, respectively, while permitting slight movement therebetween.

5. The angularly accessible head assembly as claimed in claim 3, further comprising:
a second force transmitting member which is rotatably mounted in said force transmitting chamber about a second transmitting axis that is oriented to intersect with the first transmitting axis, and which has second force-receiving and force-delivering ends opposite to each other along the second transmitting axis; and
a second joint subassembly disposed between said first force-delivering end and said second force-receiving end to transmit the torque exerted on said first force-delivering end so as to rotate said second force-receiving end about the second transmitting axis.

6. The angularly accessible head assembly as claimed in claim 5, further comprising:
a third force transmitting member which is rotatably mounted in said force transmitting chamber about a third transmitting axis that is oriented to intersect with the second transmitting axis, and which has third force-receiving and force-delivering ends opposite to each other along the third transmitting axis;
a third joint subassembly disposed between said second force-delivering end and said third force-receiving end to transmit the torque exerted on said second force-delivering end so as to rotate said third force-receiving end about the third transmitting axis; and
a fourth joint subassembly disposed between said third force-delivering end and said head to transmit the torque exerted on said third force-delivering end so as to rotate said head about the driven axis.

7. The angularly accessible head assembly as claimed in claim 6, wherein said first force transmitting member has two spherical bodies which respectively serve as said first force-receiving and force-delivering ends, said second force transmitting member is in form of a tubular body which surrounds the second transmitting axis, and said third force transmitting member has two spherical bodies which respectively serve as said third force-receiving and force-delivering ends.

8. The angularly accessible head assembly as claimed in claim 6, wherein each of said first and third force transmitting members is in form of a tubular body which surrounds a respective one of the first and third transmitting axes, and said second force transmitting member has two spherical bodies which respectively serve as said second force-receiving and force-delivering ends.

9. The angularly accessible head assembly as claimed in claim 6, wherein each of said first, second and third force transmitting members has a socket body which serves as a respective one of said first, second and third force-receiving ends, and a spherical body which serves as a respective one of said first, second and third force-delivering ends.

10. The angularly accessible head assembly as claimed in claim 6, wherein each of said first, second and third force transmitting members has a spherical body which serves as a respective one of said first, second and third force-receiving ends, and a socket body which serves as a respective one of said first, second and third force-delivering ends.

11. The angularly accessible head assembly as claimed in claim 6, wherein said first force transmitting member has socket and spherical bodies which respectively serve as said first force-receiving and force-delivering ends, said second force transmitting member is in form of a tubular body which surrounds the second transmitting axis, and said third force transmitting member has spherical and socket bodies which respectively serve as said third force-receiving and force-delivering ends.

12. The angularly accessible head assembly as claimed in claim 6, wherein said first force transmitting member has spherical and socket bodies which respectively serve as said first force-receiving and force-delivering ends, said second force transmitting member has two spherical bodies which respectively serve as said second force-receiving and force-delivering ends, and said third force transmitting member has socket and spherical bodies which respectively serve as said third force-receiving and force-delivering ends.

13. The angularly accessible head assembly as claimed in claim 5, wherein said force transmitting chamber has a bearing surface which is configured to stabilize the rotation of at least one of said first, second, and third force transmitting members about the corresponding one of the first, second and third transmitting axes.

14. The angularly accessible head assembly as claimed in claim 1, wherein the angle is at least 90 degrees.
